(19) United States
(12) Patent Application Publication
(10) Pub. No.: US 2012/0150704 A1
(43) Pub. Date: Jun. 14, 2012

(54) Voice Assisted Vehicle Recording Device For Recording, Tracking and Reporting Vehicle Business Expenses

(76) Inventor: Thomas Merlyn Acklam, Indian Trail, NC (US)

(21) Appl. No.: 12/967,338

(22) Filed: Dec. 14, 2010

(51) Int. Cl. G06Q 40/00

(52) U.S. Cl. 705/31

(57) ABSTRACT

A method of recording for future reference the use of a vehicle which is not normally used for a business purpose is being used for a business purpose and is an allowable IRS expense for that business purpose wherein, subsequent to initiating the process by pressing a button on the steering wheel or on the dashboard and prior to moving the vehicle, a recording is made of the odometer reading on the vehicle, the date of the trip and the purpose of the trip. At the completion of the trip a recording is made of the odometer reading on the vehicle to obtain the true total distance traveled and the allowable tax deductable expense for the use of the vehicle during the business purpose is recorded where the allowable tax deductable expense is based on miles traveled and other related allowable expenses incurred.

### BACKGROUND OF THE INVENTION

1. Field of the Invention

The present invention relates generally to expense tracking, and more specifically to system and method of recording date of use, time of use, purpose, tolls and mileage which is a reportable deductable IRS business expenses which can be charged against a vehicle.

2. Description of Related Art

During a business day there are various expenses which are both personal and business related. One of these expenses may be the use by an employee of his/her vehicle for a business related use which may be an IRS deductable business expense. Therefore, for tax purposes, it is important to separate this expense from nondeductible expenses by tracking and keeping a record of the tax deductable expenses as they occur. For example, a person may use his/her vehicle to meet with a customer at a remote location during a day or over a period of time to conduct business. This vehicle expense is a valid IRS deductable business expense as opposed to the expenses of operating the vehicle for personal use which are not deductable.

Thus, there is a need for a system and method for keeping track at a single location of all tax deductable business expenses which occurred during a predetermined period such as, for example, a tax year which relate to a privately owned vehicle that is used for a business purpose with a minimum amount of effort and time.

Keeping track of business related expenses is known in the prior art. More specifically, by way of example, U.S. PreGrant Publication No. 2001/0042032 to Crawshaw, et al. discloses a system that accepts and stores raw time and expense data for a plurality of businesses where each business defines a separate account that is accessible and usable by authorized users for the particular business. The system automatically converts the raw time and expense data by considering any client or project-specific billing requirements (e.g., flat-fee, maximum fee, discount, write-offs, etc.) and by applying such specific requirements to the raw time and/or expense data in generating an invoice.

U.S. PreGrant Publication No. 2004/0167808 to Fredericks, et al. discloses a method for integrating travel and expense management which enables an entity to integrate data that matches exactly and data that does not match exactly but corresponds to each other.

U.S. PreGrant Publication No. 2006/0080126 to Greer; et al. discloses a method for calculating employee expenses.

U.S. PreGrant Publication No. 2007/0094088 to Mastie; et al. discloses a method for providing paperless receipts for conducting business transactions where the electronic receipt may be passed directly to the customer.

U.S. PreGrant Publication No. 2008/0046347 to Smith; et al. discloses a process for tracking, allocating, documenting, and facilitating the reimbursement of expenses. Documentation of received and tracked expenses may be provided and linked to the tracked expenses. Because expenses may be tracked and documented immediately upon incurring the expenses, the reimbursement of the expenses is accelerated.

U.S. PreGrant Publication No. 2010/0017316 to Joseph; et al. discloses creating an expense report automatically by using transactions, business rules and profile information stored by a payment processor. The payment processor automates the end-to-end expense reporting and reimbursement processes for a company. The review, submission, approval, payment, tracking and reporting associated with employee expense reporting are by the payment processor through automated, no-touch (or minimal touch) processes.

U.S. Pat. No. 6,826,473 to Burch, et al. discloses a method that integrates navigation data, such as GPS navigation data, with Personal Digital Assistant (PDA) expense reporting functions to flexibly determine travel distances for expense reports. One aspect provided herein is a method of using a Personal Digital Assistant (PDA) to provide travel expenses for an expense report. Navigation data is used to determine a travel distance, which is associated with a PDA expense report entry.

U.S. Pat. No. 6,442,526 to Vance, et al. discloses a method for processing travel data and travel receipts.

### SUMMARY OF THE INVENTION

In an exemplary embodiment of the present invention, there is disclosed a method of recording for future reference the use of a vehicle which is not normally used for a business purpose is being used for a business purpose and is an allowable IRS expense for that business purpose, the method comprises:

recording the odometer reading on the vehicle at the start of a trip;

recording the purpose of the trip;

recording the odometer reading on the vehicle at the end of the trip to obtain the true total distance traveled; and

assigning an allowable tax deductable expense for the use of the vehicle during the business purpose;

wherein the allowable tax deductable expense is based on miles traveled and other related allowable expenses incurred.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIGS. 1A and 1B where FIG. 1A is located above FIG. 1B is a flow diagram of a method of tracking business related tax deductable expenses which relate to the business use of a privately owned vehicle.

### DESCRIPTION OF THE PREFERRED EMBODIMENT

The invention here disclosed allows a driver of a vehicle to quickly record details in his/her own voice as to the purpose of a trip. The recording can be activated by a button on the steering wheel, the dashboard of the vehicle or elsewhere within the vehicle, or via voice recognition. The use of the steering wheel button or voice recognition will allow the user to record all information while driving. Upon activation of the system, a recording may be automatically made or verbally made by the driver of the current vehicle mileage, GPS location if the vehicle is equipped with such a device, and the date and time of the day. The user can then explain the purpose of the trip to help with record keeping for business use tax deductions.

The user now drives to the business meeting and, upon completion of the meeting, returns to his/her office. Upon putting the vehicle in park at the office, the driver is prompted through the vehicles speakers, either by a recorded voice message of a tone, to confirm that the business trip is completed. Completion of the business trip may be accomplished via the driver speaking into a microphone, by pressing a button, by a display within the driver's view from the driver's seat or via a touch screen located in the vehicle. After the user confirms that the trip has been completed, the user is prompted to again identify the type of trip. The trip type category identified by the driver would be consistent with what the IRS requires for a trip in a privately owned vehicle to be considered a valid business related deductable expense such as a business related trip, commuting between jobs, a charitable purpose, etc. At this time the user may add additional details via voice recording or typing on a touch screen. The additional details will document the trip usage.

All of the information for this trip in addition to all other expense deductable trips made by this vehicle are stored within the vehicle and can be downloaded at any time via, but not limited to, Bluetooth, flash drivers, wired data ports, email attachments sent via the vehicle of the user's handheld device, etc.

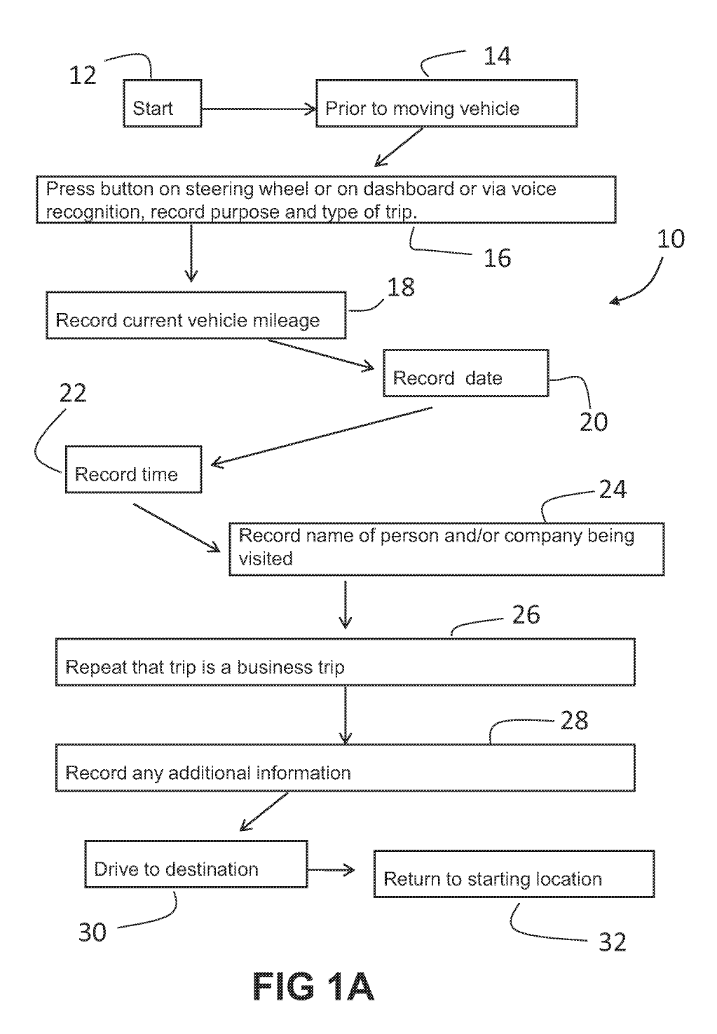

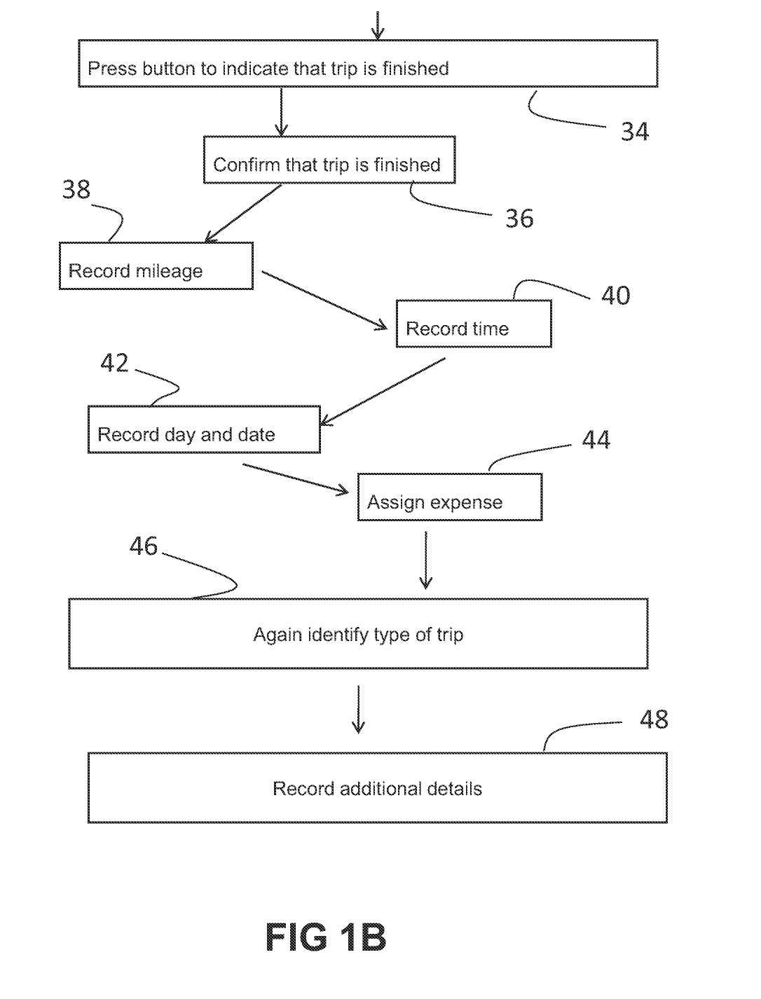

Referring to FIG. 1, there is disclosed a flow diagram 10 of a method of tracking business, charitable, etc. related IRS tax deductable expenses which are incurred by the use of a privately owned vehicle. At the start, block 12, and prior to driving away, block 14, the driver presses a button on the steering wheel or, via a voice recognition system, identifies the type of trip that is to be made, block 16. The type of trip identified by the driver should be consistent with what the IRS requires for a trip in a privately owned vehicle to be considered a valid business related deductable expense such as a business related trip, commuting between jobs, a trip for a charitable purpose, etc.

The current mileage on the vehicles odometer is now recorded, block 18, via the drivers voice, block 20, or automatically if the vehicle is so equipped. Then the driver inputs the time that the trip is starting and the date of the trip, block 22, and the name of the person and the name and address of the company being visited, block 24. At this time the driver may want to repeat that the trip is for a business related purpose, block 26.

The driver, after inputting the above noted information and any additional information, block 28, such as a stop to pick up a coworker, puts the vehicle into drive and starts the trip to his/her destination, block 30.

Upon completion of the meeting, the driver returns to his/her starting location, block 32, puts the vehicle in park and presses a button on the steering wheel or on the dash to indicate that the trip is finished, block 34. When the trip finish button is pressed, the driver is prompted via a voice request on the vehicle speaker or a tone to confirm that the trip is over, block 36. The driver now records the mileage, block 38; the time, block 40, and the day and date, block 42. The return day and date may be relevant if the trip was for more that one day.

The driver now assigns an expense which may be based on miles traveled and may include tolls which were paid. block 44. The driver again identifies the type of trip, block 46, and add to the expenses any additional details which may result in an increase in the amount of the allowable deduction such as a repair that was required to the vehicle as a result of the business trip, block 48.

The information stored in the vehicle about business related trips which are tax deductable can be for a single trip, multiple trips, a specific interval of time such as for a three month time interval, a one year time period which covers the tax year of the vehicle owner, or for the time that the driver owns the vehicle and/or uses the vehicle for business purposes.

The business stored in the vehicle is important because the IRS maintains strict requirements for expensing the use of vehicles for business or charitable purposes. With this invention accurate data can be recorded and stored with the unique ability of allowing the user to talk about the specific use for each trip which may help in future dates if further details and explanations are required.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of recording for future reference the use of a vehicle which is not normally used for a business purpose is being used for a business purpose and is an allowable IRS expense for that business purpose, the method comprises:
recording the odometer reading on the vehicle at the start of a trip;
recording the purpose of the trip;
recording the odometer reading on the vehicle at the end of the trip to obtain the true total distance traveled; and
assigning an allowable tax deductable expense for the use of the vehicle during the business purpose;
wherein the allowable tax deductable expense is based on miles traveled and other related allowable expenses incurred.

2. The method of claim 1 wherein, subsequent to starting the vehicle and prior to moving the vehicle, a button on the steering wheel or the dashboard of the vehicle is pressed prior to starting a recording.

3. The method of claim 2 wherein tolls paid are other related allowable expenses incurred.

4. The method of claim 3 wherein repairs to the vehicle which were made during the trip are other related allowable expenses incurred.

5. The method of claim 4 wherein the recording of the odometer reading at the start of the trip is done verbally.

6. The method of claim 5 wherein the recording of the purpose of the trip is done verbally.

7. The method of claim 6 wherein the recording of the purpose of the trip includes the name of the person or company being visited.

8. The method of claim 7 wherein and prior to moving the vehicle additional information which relates to the trip is recorded.

9. The method of claim 8 wherein the additional information includes a side trip to pick up a coworker.

10. The method of claim 6 wherein, at the completion of the business purpose, the odometer reading is recorded.

11. The method of claim 10 wherein, at the completion of the business purpose, the time and date is recorded.

12. The method of claim 11 wherein, at the completion of the business purpose, the tax deductable expense is recorded.
